(19) United States
(12) Patent Application Publication
(10) Pub. No.: US 2015/0099850 A1
(43) Pub. Date: Apr. 9, 2015

(54) FLUORINE-CONTAINING ELASTOMER AND A VULCANIZABLE COMPOSITION THEREOF

(71) Applicants: UNIMATEC CO., LTD., Tokyo (JP); EAGLE INDUSTRY CO., LTD., Tokyo (JP)

(72) Inventors: Akihiko Ikeda, Ibaraki (JP); Mitsuru Maeda, Ibaraki (JP); Masahi Kudo, Kanagawa (JP); Hideto Nameki, Kumamoto (JP); Kunihiko Mori, Kumamoto (JP)

(73) Assignee: EAGLE INDUSTRY CO., LTD., Tokyo (JP)

(21) Appl. No.: 14/400,060

(22) PCT Filed: Apr. 22, 2013
(86) PCT No.: PCT/JP2013/061718

§ 371 Date: Nov. 10, 2014

(30) Foreign Application Priority Data
May 15, 2012 (JP) 2012-111211

(51) Int. Cl. C08F 214/26; C09K 3/10; C08J 3/24

(52) U.S. Cl. CPC C08F 214/262; C08J 3/24; C09K 3/1009; C08J 2327/18; C09K 2003/1053
USPC 525/326.3; 526/247; 525/377

(57) ABSTRACT

A quaternary copolymer, fluorine-containing elastomer having a copolymerization composition comprising:
(A) 2.0 to 8.0 mol % of vinylidene fluoride,
(B) 60.0 to 70.0 mol % of tetrafluoroethylene,
(C) 35.0 to 25.0 mol % of perfluoro(lower alkyl vinyl ether) or perfluoro(lower alkoxy-lower alkyl vinyl ether), and
(D) 0.2 to 3.0 mol % of a perfluoro unsaturated nitrile compound, and having a Mooney viscosity ML₁₊₁₀(121° C.) of 65 to 110, as well as a vulcanizable fluorine-containing elastomer composition comprising said fluorine-containing elastomer and a bisamidoxime compound in an amount of 0.2 to 5 parts by weight based on 100 parts by weight of the fluorine-containing elastomer. A sealing material obtained by vulcanization-molding of the fluorine-containing elastomer has not only excellent compression set characteristics and plasma resistance, but also low adhesion to metal at a higher temperature, specifically 150° C.

### TECHNICAL FIELD

The present invention relates to a fluorine-containing elastomer and a vulcanizable composition thereof. More particularly, the present invention relates to a fluorine-containing elastomer that is used as a vulcanization molding material of a sealing material used for plasma irradiation, etc.; and a vulcanizable composition thereof.

### BACKGROUND ART

Seals for semiconductor manufacturing devices are applied as seals that are used, for example, in process chambers for performing an etching process or for treatments, such as formation of thin films, on the surfaces of silicon wafers, which are semiconductor substrates. The seals are required to have heat resistance, low gas permeability, low dust characteristics (little generation of dust from seals), and other properties. In the etching process of silicon wafers, plasma irradiation is performed under the atmosphere of oxygen or CF₄, and therefore the gas (oxygen or halogen) becomes an excited state. As a result, the seals for semiconductor manufacturing devices have problems that they become vulnerable to deterioration; the surfaces of the seals become brittle; and the deteriorated materials and embrittled materials are dispersed and attached to the silicon wafers.

Moreover, fluorine-containing elastomers, which are conventionally used as sealing materials, are required to contain a reinforcing agent, such as carbon black, silica, or titanium oxide, as a filler so as to improve their normal state physical properties (e.g., mechanical strength) and compression set. In polyol vulcanization or amine vulcanization for vulcanizing a fluorine-containing elastomer composition containing such a reinforcing agent, it is necessary to blend, in addition to a vulcanizing agent, an acid acceptor that is a compound of metal, such as Mg, Pb, Ca, Al, or Zn, as a filler. Since these inorganic fillers cause particle generation, a formulation that does not use an inorganic filler is considered to reduce the amount of particle generation.

However, fluorine-containing elastomers that do not contain an inorganic filler not only make it difficult to ensure normal state physical properties and compression set required as sealing materials, but also worsen kneading properties during blending. Moreover, even when an inorganic filler is not used, deteriorated sealing materials themselves could cause particle generation. For this reason, fluorine-containing elastomers that form sealing materials are also required to contribute to the reduction in the amount of particles generation, namely the improvement in plasma resistance.

Furthermore, for use in gate valve applications, fluorine-containing elastomers having a strong adhesion to metal may cause problems due to themselves such that the valve does not open, or that the sealing material is removed when the valve opens. Hence, fluorine-containing elastomers are required also to have low adhesion.

Meanwhile, in semiconductor manufacturing devices, cyano group-containing perfluoroelastomers and the like having excellent heat resistance are used to meet the demand for use of the seals at temperatures as high as 300° C. As cyano group-containing perfluoroelastomers (fluorine-containing elastomers) having excellent heat resistance in such a high-temperature use environment of semiconductor manufacturing devices, and as vulcanizing agents thereof, those shown below are conventionally proposed.

Fluorine-containing elastomers having a copolymerization composition comprising (A) tetrafluoroethylene in an amount of 53 to 79.8 mol %, preferably 64.4 to 72.6 mol %, and more preferably 69.3 mol %; (B) perfluoro(methyl vinyl ether) in an amount of 20 to 45 mol %, preferably 27 to 35 mol %, and more preferably 30 mol %; and (C) a perfluoro unsaturated nitrile compound represented by the general formula:

CF₂═CF[OCF₂CF(CF₃)]ₓO(CF₂)ₙCN

wherein n is 1 to 4, and x is 1 to 2, in an amount of 0.2 to 2 mol %, preferably 0.4 to 1.0 mol %, and more preferably 0.7 mol % are known. Such fluorine-containing elastomers are supposed to be cured with a bisaminophenol or aromatic tetramine (Patent Document 1).

The present applicant has proposed vulcanizing this type of fluorine-containing elastomer using a bisamidoxime compound represented by the general formula:

HON═C(NH₂)—(CF₂)ₙ—C(NH₂)═NOH [I]

, wherein n is 1 to 10, as a vulcanizing agent. Examples of fluorine-containing elastomers usable in this case include those having a copolymerization composition comprising (A) 45 to 75 mol % of tetrafluoroethylene, (B) 54.8 to 20 mol % of perfluoro(lower alkyl vinyl ether) or perfluoro(lower alkoxy-lower alkyl vinyl ether), and (C) 0.2 to 5 mol % of a perfluoro unsaturated nitrile compound. In the examples of Patent Document 2, fluorine-containing elastomers having a copolymerization composition in which the molar ratio of (A):(B):(C) is 63.5:34.9:1.6 or 68.8:30.0:1.2 are used (Patent Document 2).

The present applicant has also proposed vulcanizing this type of fluorine-containing elastomer using a bisamidorazone compound as a vulcanizing agent. Examples of fluorine-containing elastomers usable here include those having a copolymerization composition comprising (A) 45 to 75 mol % of tetrafluoroethylene, (B) 50 to 25 mol % of perfluoro(lower alkyl vinyl ether) or perfluoro(lower alkoxy-lower alkyl vinyl ether), and (C) 0.1 to 5 mol % of a perfluoro unsaturated nitrile compound. In the examples of Patent Document 3, fluorine-containing elastomers having a copolymerization composition in which the molar ratio of (A):(B):(C) is 57.3:39.6:2.8 are used (Patent Document 3).

The fluorine-containing elastomer disclosed in Patent Document 2 has a cyano group that undergoes a crosslinking reaction with a bisamidoxime compound, which is used as a vulcanizing agent. A fluorine-containing elastomer composition prepared by compounding a vulcanizing agent with the fluorine-containing elastomer has a good processability, such as roll kneadability, and is expected to produce a vulcanization molded product having satisfactory heat resistance and solvent resistance; and the compression set values were measured at 275° C. or 300° C. for 70 hours. In terms of the compression set value at 300° C., however, the fluorine-containing elastomer is not considered to have heat resistance sufficient for use at temperatures as high as 300° C. in semiconductor manufacturing devices.

As a fluorine-containing elastomer composition of a fluorine-containing elastomer having a cyano group as a crosslinkable group that enables a vulcanized product of the elastomer to prevent weight loss caused by plasma irradiation even when it is used under plasma irradiation conditions, and when it is used under high temperature conditions of 300° C., and that exhibits excellent heat resistance even under high temperature conditions of 300° C., the present inventor also proposes a fluorine-containing elastomer composition that does not contain an inorganic filler, the composition comprising a fluorine-containing elastomer and a bisamidoxime compound as a vulcanizing agent in an amount of 0.2 to 5 parts by weight based on 100 parts by weight of the fluorine-containing elastomer, the elastomer having a copolymerization composition comprising (A) 72.8 to 74.0 mol % of tetrafluoroethylene, (B) 26.8 to 24.0 mol % of perfluoro(lower alkyl vinyl ether) or perfluoro(lower alkoxy-lower alkyl vinyl ether), and (C) 0.2 to 3.0 mol % of a perfluoro unsaturated nitrile compound (Patent Document 4).

Usable sealing materials for semiconductor manufacturing devices can be formed by vulcanization molding of the fluorine-containing elastomer using a bisamidoxime compound as a vulcanizing agent. The obtained sealing materials exhibit excellent heat resistance even without containing inorganic fillers, such as carbon black and silica; and the sealing materials have excellent high temperature heat resistance, which is indicated by compression set values at 300° C. or more, specifically at 300° C. and 315° C. Therefore, the sealing materials such as O rings can retain excellent sealing properties even at temperatures as high as 300° C. or more.

Moreover, since the fluorine-containing elastomer composition does not contain inorganic fillers, when the sealing materials are used under plasma irradiation conditions, fine particles containing metal elements are not generated, and weight loss caused by the generation of such fine particles is prevented. Thus, the sealing materials are suitably used for semiconductor manufacturing devices. Furthermore, since the fluorine-containing elastomer composition has excellent non-adhesiveness to stainless steel plates, aluminum plates, and other metal plates, silica glass plates, silicon plates and the like, when they are used for gate valves, which are attached to a region to be exposed to plasma, in a gate portion through which a substrate for forming a semiconductor is transferred from a spare chamber to a process chamber or vice versa in a vacuum system, such as effect is also caused that the sealing materials are less adhesive to the metals in contact therewith at the temperature condition of 80° C.

### PRIOR ART DOCUMENT

### Patent Document

[Patent Document 1] JP-B-2-59177

[Patent Document 2] JP-B-3082626

[Patent Document 3] JP-B-2850943

[Patent Document 4] JP-A-2009-161662

[Patent Document 5] JP-B-2770769

### OUTLINE OF THE INVENTION

### Problem to be Solved by the Invention

The fluorine-containing elastomer composition disclosed in Patent Document 4 above has excellent compression set characteristics and excellent plasma resistance to O₂ plasma; however, there is a demand for improvement in non-adhesion to metal with which the sealing material is in contact at a higher temperature, and in plasma resistance to O₂—CF₄ mixed gas.

An object of the present invention is to provide a fluorine-containing elastomer that not only has excellent compression set characteristics, plasma resistance, and other properties, but also exhibits low adhesion to metal at a higher temperature, specifically 150° C.; and also to provide a vulcanizable composition thereof.

### Means for Solving the Problem

The above object of the present invention can be achieved by a quaternary copolymer, fluorine-containing elastomer having a copolymerization composition comprising:

(A) 2.0 to 8.0 mol % of vinylidene fluoride,

(B) 60.0 to 70.0 mol % of tetrafluoroethylene,

(C) 35.0 to 25.0 mol % of perfluoro(lower alkyl vinyl ether) or perfluoro(lower alkoxy-lower alkyl vinyl ether), and

(D) 0.2 to 3.0 mol % of a perfluoro unsaturated nitrile compound, and having a Mooney viscosity ML₁₊₁₀(121° C.) of 65 to 110, as well as by a vulcanizable fluorine-containing elastomer composition comprising said fluorine-containing elastomer and a bisamidoxime compound in an amount of 0.2 to 5 parts by weight based on 100 parts by weight of the fluorine-containing elastomer.

### Effect of the Invention

A sealing material obtained by vulcanization-molding the fluorine-containing elastomer composition of the present invention exhibits low adhesion to metal with which the sealing material is in contact under higher temperature conditions of 150° C.; thus, the sealing material is effectively used for applications, such as gate valves. Moreover, the sealing material has excellent plasma resistance not only to O₂ plasma irradiation, but also to plasma irradiation using O₂—CF₄ mixed gas having any mixture volume ratio.

Patent Document 4 above indicates that a fluorine-containing elastomer having a copolymerization composition comprising (A) 72.8 to 74.0 mol % of tetrafluoroethylene, (B) 26.8 to 24.0 mol % of perfluoro(lower alkyl vinyl ether) or perfluoro(lower alkoxy-lower alkyl vinyl ether), and (C) 0.2 to 3.0 mol % of a perfluoro unsaturated nitrile compound, can be copolymerized with fluorinated olefins and various vinyl compounds in an amount (about 20 mol % or less) that does not inhibit the copolymerization reaction and does not impair vulcanizate physical properties. Vinylidene fluoride is referred to as an example of fluorinated olefins.

As a result of copolymerization with 2.0 to 8.0 mol %, preferably 3.0 to 7.0 mol % of vinylidene fluoride, the fluorine-containing elastomer composition of the present invention exhibits low adhesion to metal with which the sealing material is in contact under higher temperature conditions of 150° C. As shown in Comparative Example 2, described later, in the case of a quaternary copolymer in which 10.0 mol % of vinylidene fluoride and 58.6 mol % of tetrafluoroethylene are copolymerized, the above-mentioned low adhesion is more reliably secured; however, compression set characteristics and plasma resistance are inferior. Therefore, the indication of Patent Document 4, that is, not more than about 20 mol % of vinylidene fluoride can be copolymerized, is not considered to teach or suggest the present invention.

### EMBODIMENTS FOR CARRYING OUT THE INVENTION

The copolymerization ratio of vinylidene fluoride as Component (A) is 2.0 to 8.0 mol %, preferably 3.0 to 7.0 mol %, as described above. When the copolymerization ratio of Component (A) is less than this range, particularly when Component (A) is not used, compression set characteristics and plasma resistance are significantly excellent, while non-adhesion to metal at 150° C. is completely absent, as shown in the results of Comparative Example 1, described later. In contrast, when the copolymerization ratio of Component (A) is greater than this range, a completely opposite tendency appears; that is, non-adhesion to metal at 150° C. is remarkably excellent, while compression set characteristics and plasma resistance are inferior.

The copolymerization ratio of tetrafluoroethylene as Component (B) is set to be 60.0 to 70.0 mol %, which is further lower than the lower limit in Patent Document 4 above. When the copolymerization ratio is lower than this range, the fluorine-containing elastomer is inferior in heat resistance. On the other hand, when the copolymerization ratio is higher than this range, the fluorine-containing elastomer behaves like a resin, rather than an elastomer, resulting in a deterioration of seal performance and inferior processability.

Moreover, the copolymerization ratio of Component (C), i.e., perfluoro(lower alkyl vinyl ether) or perfluoro(lower alkoxy-lower alkyl vinyl ether), is set to be 35.0 to 25.0 mol %. When the copolymerization ratio is lower than this range, the ratio of tetrafluoroethylene in the copolymer relatively increases, and thus the copolymer becomes almost like a resin, as indicated by compression set values at 250° C., leading to a significant deterioration of seal performance. In contrast, when the copolymerization ratio is higher than this range, mechanical strength and heat resistance decrease.

As comonomer Component (C), i.e., perfluoro(lower alkyl vinyl ether), generally, perfluoro(methyl vinyl ether), perfluoro(ethyl vinyl ether), perfluoro(propyl vinyl ether), and the like are used. Moreover, as perfluoro(lower alkoxy-lower alkyl vinyl ether), for example, the following compounds are used:

CF₂═CFOCF₂CF(CF₃)OCₙF₂ₙ₊₁ (n:1 to 5)

CF₂═CFO(CF₂)₃OCₙF₂ₙ₊₁ (n:1 to 5)

CF₂═CFOCF₂CF(CF₃)O(CF₂O)ₘCₙF₂ₙ₊₁ (n:1 to 5,m:1 to 3)

CF₂═CFO(CF₂)₂OCₙF₂ₙ₊₁ (n:1 to 5)

Among these, those in which the CₙF₂ₙ₊₁ group is CF₃ are particularly preferably used.

Moreover, as comonomer Component (D), i.e., perfluoro unsaturated nitrile compound, which is a crosslinking site monomer, the following compounds are used:

CF₂═CFO(CF₂)ₙOCF(CF₃)CN (n:2 to 5)

CF₂═CF[OCF₂CF(CF₃)]ₙO(CF₂)ₘCN (n:1 to 2,m: 1 to 6)

CF₂═CFO(CF₂)ₙCN (n:1 to 8)

CF₂═CF[OCF₂CF(CF₃)]ₙOCF₂CF(CF₃)CN (n:1 to 2)

CF₂═CFO(CF₂)ₙ(p-C₆H₄)CN (n:1 to 6)

The amount of Component (D) (perfluoro unsaturated nitrile compound) in the copolymer is 0.2 to 3.0 mol %, and preferably 0.5 to 2.0 mol %, which are necessary amounts as a crosslinkable group.

The copolymerization reaction of these monomers is generally carried out as follows. Water, a fluorine-containing emulsifier such as ammonium perfluorooctanoate, and a buffer such as potassium dihydrogen phosphate are charged in a stainless steel autoclave. Then, tetrafluoroethylene, perfluoro(lower alkyl vinyl ether) or perfluoro(lower alkoxy-lower alkyl vinyl ether), and a perfluoro unsaturated nitrile compound are added sequentially. After the temperature is raised to about 50 to 80° C., a redox system catalyst consisting of a radical generator such as ammonium persulfate and a reducing agent such as sodium sulfite are added. The reaction pressure is preferably maintained at about 0.75 to 0.85 MPa. Accordingly, in order to increase the reactor internal pressure, which drops with the progress of the reaction, it is preferably to perform the reaction while additionally adding a mixture of these three monomers in several batches. The obtained quaternary copolymer, fluorine-containing elastomer has a Mooney viscosity ML₁₊₁₀(121° C.) of 65 to 110.

The quaternary polymer essentially containing the above-described components can be copolymerized with other fluorinated olefins, various vinyl compounds, etc., in an amount that does not inhibit the copolymerization reaction and does not impair the vulcanizate properties (about 20 mol % or less). Examples of fluorinated olefins include monofluoroethylene, trifluoroethylene, trifluoropropylene, pentafluoropropylene, hexafluoropropylene, hexafluoroisobutylene, chlorotrifluoroethylene, dichlorodifluoroethylene, and the like. Examples of vinyl compounds include ethylene, propylene, 1-butene, isobutylene, methyl vinyl ether, ethyl vinyl ether, butyl vinyl ether, cyclohexyl vinyl ether, vinyl acetate, vinyl propionate, vinyl chloride, vinylidene chloride, trifluorostyrene, and the like.

The fluorine-containing elastomer comprising such a quaternary polymer is compounded with a bisamidoxime compound, which is used as a vulcanizing agent, represented by the general formula:

HON═C(NH₂)—(CF₂)ₙ—C(NH₂)═NOH [I]

wherein n is 1 to 10, as described in Patent Document 2, or
a bisamidoxime compound, which is used as a vulcanizing agent represented by the general formula:

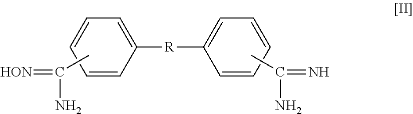

wherein R is alkylidene group having C₁˜C₆ or perfluoroalkylidene group having C₁˜C₁₀, as described in Patent Document 5,
preferably bisamidoxime compound [I], in an amount of 0.2 to 5 parts by weight, and preferably 0.5 to 2 parts by weight, based on 100 parts by weight of the fluorine-containing elastomer.

The preparation of a fluorine-containing elastomer composition containing a bisamidoxime compound as a vulcanizing agent is carried out by kneading using two-rolls and the like at about 30 to 60° C. The composition is crosslinked by heating at about 100 to 250° C. for about 1 to 120 minutes. Secondary vulcanization is carried out, if necessary, at about 150 to 280° C. in an inert gas such as nitrogen gas atmosphere, and it is preferable to perform oven vulcanization while gradually raising the temperature, as described in the following examples.

A vulcanization molded product of the fluorine-containing elastomer is effectively used as a sealing member for parts that are exposed to plasma gas, such as O₂ gas, O₂—CF₄ mixed gas having any mixture volume ratio, furthermore, CF₄ gas, or the like, for example, a gate valve, vacuum chamber, vacuum valve, etc., of a chamber for processing surface treatment of silicon wafers, in semiconductor manufacturing devices, such as plasma cleaning apparatus, plasma etching apparatus, plasma ashing apparatus, plasma CVD apparatus, ion injection apparatus, and sputtering apparatus.

### EXAMPLES

The following describes the present invention with reference to examples.

### Example 1

Distilled water (60 kg), 2000 g of ammonium perfluorooctanoate, and 800 g of potassium dihydrogen phosphate were charged in a stainless steel autoclave having an inner volume of 100 L, and the air in the autoclave was replaced by nitrogen, followed by pressure reduction. Then, 0.1 kg of vinylidene fluoride [VdF], 1.1 kg of tetrafluoroethylene[TFE], 1.3 kg of perfluoro(methyl vinyl ether) [FMVE], and 100 g of perfluoro(3-oxa-8-cyano-1-octene) [CPeVE] were sequentially charged thereto, and the temperature was increased to 60° C. An aqueous solution (5 L) in which 70 g of ammonium persulfate and 15 g of sodium sulfite were dissolved was added thereto, starting the polymerization reaction.

During the polymerization reaction, each of VdF, TFE, FMVE, and CPeVE was divisionally added at a rate of 0.06 kg/hr, 1.2 kg/hr, 1.2 kg/hr, and 85 g/hr, respectively, while the pressure in the autoclave was maintained at 0.75 to 0.85 MPa. After the divisional addition was stopped 7 hours after the start of the polymerization reaction, the autoclave was cooled, and the residual gas was purged, thereby obtaining 76 kg of an aqueous latex having a solid matters content of 27 wt. %. The obtained aqueous latex was added to 76 L of a 5 wt. % magnesium chloride aqueous solution for coagulation, followed by water washing and drying at 80° C. for 70 hours, thereby obtaining 17.0 kg (yield: 83%) of a white rubbery quaternary copolymer A.

This rubbery quaternary polymer had a Mooney viscosity ML₁₊₁₀(121° C.) of 85, and the infrared absorption spectrum and NMR analysis confirmed that the rubbery terpolymer had the following composition:

VdF: 4.9 mol %

TFE: 65.0 mol %

FMVE: 28.8 mol %

CPeVE: 1.3 mol %

### Example 2

Distilled water (60 kg), 2000 g of ammonium perfluorooctanoate, and 800 g of potassium dihydrogen phosphate were charged in a stainless steel autoclave having an inner volume of 100 L, and the air in the autoclave was replaced by nitrogen, followed by pressure reduction. Then, 0.1 kg of vinylidene fluoride [VdF], 1.1 kg of tetrafluoroethylene [TFE], 1.3 kg of perfluoro(methyl vinyl ether) [FMVE], and 150 g of perfluoro(3,7-dioxa-8-cyano-1-nonene) [CEPVE] were sequentially charged thereto, and the temperature was increased to 60° C. An aqueous solution (5 L) in which 70 g of ammonium persulfate and 15 g of sodium sulfite were dissolved was added thereto, starting the polymerization reaction.

During the polymerization reaction, each of VdF, TFE, FMVE, and CEPVE was divisionally added at a rate of 0.06 kg/hr, 1.2 kg/hr, 1.2 kg/hr, and 120 g/hr, respectively, while the pressure in the autoclave was maintained at 0.75 to 0.85 MPa. After the divisional addition was stopped 7 hours after the start of the polymerization reaction, the autoclave was cooled, and the residual gas was purged, thereby obtaining 76 kg of an aqueous latex having a solid matters content of 26 wt. %. The obtained aqueous latex was added to 76 L of a 5 wt. % magnesium chloride aqueous solution for coagulation, followed by water washing and drying at 80° C. for 70 hours, thereby obtaining 17.6 kg (yield: 86%) of a white rubbery quaternary copolymer B.

This rubbery quaternary polymer had a Mooney viscosity ML₁₋₁₀(121° C.) of 88, and the infrared absorption spectrum and NMR analysis confirmed that the rubbery terpolymer had the following composition:

VdF: 5.1 mol %

TFE: 64.6 mol %

FMVE: 28.7 mol %

CEPVE: 1.6 mol %

### Reference Example 1

Distilled water (60 kg), 2000 g of ammonium perfluorooctanoate, and 800 g of potassium dihydrogen phosphate were charged in a stainless steel autoclave having an inner volume of 100 L, and the air in the autoclave was replaced by nitrogen, followed by pressure reduction. Then, 1.2 kg of tetrafluoroethylene [TFE], 1.3 kg of perfluoro(methyl vinyl ether) [FMVE], and 100 g of perfluoro(3-oxa-8-cyano-1-octene) [CPeVE] were sequentially charged thereto, and the temperature was increased to 60° C. An aqueous solution (5 L) in which 70 g of ammonium persulfate and 15 g of sodium sulfite were dissolved was added thereto, starting the polymerization reaction.

During the polymerization reaction, each of TFE, FMVE, and CPeVE was divisionally added at a rate of 1.3 kg/hr, 1.2 kg/hr, and 85 g/hr, respectively, while the pressure in the autoclave was maintained at 0.75 to 0.85 MPa. After the divisional addition was stopped 7 hours after the start of the polymerization reaction, the autoclave was cooled, and the residual gas was purged, thereby obtaining 81 kg of an aqueous latex having a solid matters content of 26 wt. %. The obtained aqueous latex was added to 81 L of a 5 wt. % magnesium chloride aqueous solution for coagulation, followed by water washing and drying at 80° C. for 70 hours, thereby obtaining 17.9 kg (yield: 87%) of a white rubbery terpolymer C.

This rubbery terpolymer had a Mooney viscosity ML₁₊₁₀(121° C.) of 82, and the infrared absorption spectrum and NMR analysis confirmed that the rubbery terpolymer had the following composition:

TFE: 68.8 mol %

FMVE: 29.9 mol %

CPeVE: 1.3 mol %

### Reference Example 2

Distilled water (60 kg), 2000 g of ammonium perfluorooctanoate, and 800 g of potassium dihydrogen phosphate were charged in a stainless steel autoclave having an inner volume of 100 L, and the air in the autoclave was replaced by nitrogen, followed by pressure reduction. Then, 0.15 kg of vinylidene fluoride [VdF], 1.0 kg of tetrafluoroethylene [TFE], 1.3 kg of perfluoro(methyl vinyl ether) [FMVE], and 150 g of perfluoro(3,7-dioxa-8-cyano-1-nonene) [CEPVE] were sequentially charged thereto, and the temperature was increased to 60° C. An aqueous solution (5 L) in which 70 g of ammonium persulfate and 15 g of sodium sulfite were dissolved was added thereto, starting the polymerization reaction.

During the polymerization reaction, each of VdF, TFE, FMVE, and CEPVE was divisionally added at a rate of 0.12 kg/hr, 1.2 kg/hr, 1.2 kg/hr, and 120 g/hr, respectively, while the pressure in the autoclave was maintained at 0.75 to 0.85 MPa. After the divisional addition was stopped 7 hours after the start of the polymerization reaction, the autoclave was cooled, and the residual gas was purged, thereby obtaining 81 kg of an aqueous latex having a solid matters content of 26 wt. %. The obtained aqueous latex was added to 81 L of a 5 wt. % magnesium chloride aqueous solution for coagulation, followed by water washing and drying at 80° C. for 70 hours, thereby obtaining 18.7 kg (yield: 89%) of a white rubbery quaternary copolymer D.

This rubbery quaternary polymer had a Mooney viscosity ML₁₊₁₀(121° C.) of 95, and the infrared absorption spectrum and NMR analysis confirmed that the rubbery terpolymer had the following composition:

VdF: 10.0 mol %

TFE: 58.6 mol %

FMVE: 29.8 mol %

CEPVE: 1.6 mol %

### Example 3

The above bisamidoxime compound ([I]; n=4) (0.7 parts by weight) was added to 100 parts by weight of vinylidene fluoride-tetrafluoroethylene-perfluoro(methyl vinyl ether)-perfluoro(3-oxa-8-cyano-1-octene) [molar ratio=4.9:65.0:28.8:1.3] quaternary copolymer [copolymer A], and the mixture was kneaded on a two-roll mill at a temperature of 30 to 60° C. The kneaded product was subjected to press vulcanization (primary vulcanization) at 190° C. for 15 minutes, and then oven vulcanization (secondary vulcanization) in a nitrogen gas atmosphere under the following conditions. Thereafter, the temperature was maintained at 100° C. for 2 hours and then reduced to room temperature.

temperature raised from room temperature to 90° C. over 0.5 hours,

at 90° C. for 4 hours,

temperature raised from 90° C. to 200° C. over 6 hours,

at 200° C. for 22 hours,

temperature raised from 200° C. to 250° C. over 4 hours, and

at 250° C. for 22 hours.

### Example 4

In Example 3, Copolymer B (quaternary polymer of vinylidene fluoride-tetrafluoroethylene-perfluoro(methyl vinyl ether)-perfluoro(3,7-dioxa-8-cyano-1-nonene); molar ratio=5.1:64.6:28.7:1.6) was used in place of Copolymer A and the amount of the bisamidoxime compound before-mentioned ([I]; n=4) were changed to 1.2 parts by weight.

As for the quaternary polymers obtained in Examples 3-4, each of the following items was measured.
Normal state physical properties: JIS K-6253 corresponding to ISO 7619 (hardness)
   JIS K-6251 corresponding to ISO 37 (tensile testing)
Compression set: ASTM Method B; measured using a P-24 O ring at 250° C. for 70 hours
Plasma irradiation test (weight loss rate): using RBH-3030 produced by Ulvac
   O₂:CF₄=10:1 (in vol.) mixed gases
   RF output: 1500 W
   Irradiation time: 30 hours
   Degree of vacuum: 0.15 Torr

Adhesion test: A P-24 O ring was sandwiched between two 5×5 cm
stainless steel plates (SUS plates), and compressed by
25%, followed by heating at 150° C. for 15 hours and then
cooling at a room temperature for 24 hours, then the
maximum load when the two plates were pulled at a
rate of 100 mm/min. was measured

### Comparative Example 1

In Example 3, a terpolymer of TFE-FMVE-CPeVE (Copolymer C; copolymerization monomer molar ratio=68.8:29.9:1.3) was used in place of Copolymer A, and vulcanization and measurement were carried out in the same manner as described above.

### Comparative Example 2

In Example 4, a quaternary copolymer of VdF-TFE-FMVE-CEPVE (Copolymer D; copolymerization monomer molar ratio=10.0:58.6:29.8:1.6) was used in place of Copolymer A, and vulcanization and measurement were carried out in the same manner as described above.

The results obtained in the above examples and comparative examples are show in the table below.

TABLE

| | |
|---|---|
| Ex. | Comp. Ex. |

| Measurement item | 3 | 4 | 1 | 2 |
|---|---|---|---|---|
| Hardness (Duro-A) | 63 | 60 | 65 | 57 |
| Tensile testing | | | | |
| 100% modulus (MPa) | 2.2 | 1.7 | 2.5 | 1.3 |
| Breaking strength (MPa) | 19.0 | 16.2 | 25.0 | 18.3 |
| Elongation at break (%) | 270 | 280 | 270 | 320 |
| Compression set | | | | |
| 250° C., 70 hrs (%) | 23 | 23 | 17 | 48 |
| Plasma testing | | | | |
| Weight loss rate (%) | 1.5 | 1.6 | 0.3 | 4.3 |
| Adhesion test | | | | |
| SUS plate (N) | 170 | 175 | 520 | 140 |

1: A quaternary copolymer, fluorine-containing elastomer having a copolymerization composition comprising:
(A) 2.0 to 8.0 mol % of vinylidene fluoride,
(B) 60.0 to 70.0 mol % of tetrafluoroethylene,
(C) 35.0 to 25.0 mol % of perfluoro(lower alkyl vinyl ether) or perfluoro(lower alkoxy-lower alkyl vinyl ether), and
(D) 0.2 to 3.0 mol % of a perfluoro nitrile compound.

2: The quaternary copolymer, fluorine-containing elastomer according to claim 1, which has a Mooney viscosity ML₁₊₁₀ (121° C.) of 65 to 110.

3: A vulcanizable fluorine-containing elastomer composition comprising the fluorine-containing elastomer of claim 1 and a bisamidoxime compound in an amount of 0.2 to 5 parts by weight based on 100 parts by weight of the fluorine-containing elastomer.

4: The vulcanizable fluorine-containing elastomer composition according to claim 3, wherein a bisamidoxime compound represented by the general formula:
HON═C(NH₂)—(CF₂)ₙ—C(NH2)═NOH
wherein n is an integer of 1 to 10, is used.

5: A sealing material obtained by vulcanization molding of the vulcanizable fluorine-containing elastomer composition of claim 3.

6: The sealing material according to claim 5, which is used for plasma irradiation.

7: The sealing material according to claim 6, which is used for plasma irradiation using O₂ gas or O₂—CF₄ mixed gas.

8: The sealing material according to claim 6, which is used for a semiconductor manufacturing device.

9: The sealing material according to claim 8 which is used for a chamber for processing surface treatment of silicon wafers.

10: The sealing material according to claim 6, which is used for a gate valve.

11: A sealing material obtained by vulcanization molding of the vulcanizable fluorine-containing elastomer composition of claim 4.

12: The sealing material according to claim 11, which is used for plasma irradiation.

13: The sealing material according to claim 12, which is used for plasma irradiation using O₂ gas or O₂—CF₄ mixed gas.

14: The sealing material according to claim 12, which is used for a semiconductor manufacturing device

15: The sealing material according to claim 14 which is used for a chamber for processing surface treatment of silicon wafers.

16: The sealing material according to claim 12, which is used for a gate valve.
